(19) United States
(12) Patent Application Publication
(10) Pub. No.: US 2006/0204061 A1
(43) Pub. Date: Sep. 14, 2006

(54) Method for the acquisition of an image of a finger print

(75) Inventor: Jean-Francois Mainguet, Grenoble (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: ATMEL GRENOBLE S.A., Saint Egreve (FR)

(21) Appl. No.: 10/565,071

(22) PCT Filed: Jul. 16, 2004
(86) PCT No.: PCT/EP04/51527

§ 371 Date: Jan. 18, 2006

(51) Int. Cl. G05B 19/00; G06K 9/74; G06K 9/00; H04K 1/00

(52) U.S. Cl. 382/124; 340/5.1; 340/5.52; 356/71; 713/186

(57) ABSTRACT

The invention relates to the recognition of digital finger prints, more particularly to recognition by an elongate bar of sensors able to detect crests and valleys of finger prints when a finger is passed in a relative manner in front of a sensor in an essentially parallel manner in relation to the direction of elongation of said bar. The inventive method comprises the following operations: successive partially overlapping images are acquired under the control of a processor; displacement of the first image in relation to a second image is examined in order to provide a better correlation between the two images; said displacement component is determined in terms of pixels in a perpendicular direction with respect to the elongate sensor; the displacement component is compared to at least one threshold; according to the result of the comparison, a delay T imposed by the processor before the acquisition of a following image is preserved, or increased or decreased by a time increment dT. As a result, the correlation search is adapted according to the speed, which is unknown, of displacement of the finger.

The invention relates to the recognition of fingerprints, and more particularly to the recognition on the basis of an elongate bar of sensors capable of detecting the ridges and valleys of fingerprints during the relative movement of a finger with respect to the sensor substantially perpendicularly to the direction of elongation of the bar.

Such sensors of elongate form, which are smaller than the image of the finger to be gathered and which cannot therefore gather this image other than by virtue of the relative movement, have already been described. These sensors can operate mainly by optical or capacitive or thermal or piezoelectric detection.

These sensors have the advantage, as compared with movementless sensors on which the finger is left stationary, of having reduced cost on account of the small area of silicon that they use. However, they require a reconstruction of the global image of the finger since this image is acquired only line by line or several lines at a time.

If the image is thus acquired progressively, it is in principle necessary to possess a reference of speed of relative movement of the finger with respect to the sensor, or to impose a fixed speed of movement. This therefore requires additional specific means.

In the French patent published under the number FR 2 749 955 has been described a principle of detection by an elongate sensor comprising several lines for acquiring partial images of the print successively, these images mutually overlapping, so that it is possible, by searching for a correlation between two successive images, to superimpose successive images shifted in tandem with the movement of the finger and progressively reconstruct the global image of the print without needing to ascertain through additional means the speed of movement of the finger with respect to the sensor.

This type of reconstruction operates well but requires facilities for increasing the speed of movement range for which operation remains possible. It also requires facilities for minimizing the number of calculations to be done in order to reconstruct the image, while maintaining good accuracy.

The invention is aimed at improving the possibilities of reconstructing the image without excessively increasing the calculations required for this reconstruction.

According to the invention, there is proposed a method of acquiring a fingerprint image by moving a finger in front of an elongate sensor of images, comprising the following operations:
acquiring a succession of mutually overlapping partial images, under the control of a processor,
searching for that displacement of a first image, with respect to a second image, which affords the best correlation between the two images, and determining, as a number of image pixels, the component of this displacement in the direction perpendicular to the elongate sensor,
comparing this component of displacement with at least one threshold,
as a function of the result of the comparison, maintaining, or increasing or decrementing by a time increment dT, a delay T imposed by the processor before the acquisition of a next image.

The rate of acquisition of the partial images therefore varies as a function of the speed of displacement of the finger over the sensor in the expected direction of movement.

The image is thereafter reconstructed as a function of the displacements in the direction of the movement and perpendicularly to the movement, the displacements considered between two successive overlapping images being those which give the best correlation between images. The correlation value is a mathematical quantity which represents the greater or lesser resemblance between the two images, and it is possible to choose as correlation quantity a function which exhibits a maximum or (preferably) a minimum when the two images (first image shifted and second image) are identical. At each new image, the acquisition delay is readjusted in a direction tending to make the displacement which gives the best correlation remain almost constant around the threshold considered.

There is preferably a high threshold and a low threshold, the overshooting of the high threshold bringing about a decrementation by dT of the delay T and the undershooting of the low threshold bringing about an incrementation by dT of the delay T. The thresholds are preferably a few pixels. The difference between the high threshold and the low threshold is preferably one pixel. The thresholds are preferably respectively 2 and 3 pixels. This implies that the delay arranged between two successive acquisitions is adjusted permanently so that the image displacement between two successive acquisitions is around 2 to 3 pixels.

For an acceptable compromise in terms of calculation time, the correlation is performed on a restricted portion of the image provided by the sensor. For example, the correlation is done on an image portion consisting of one or more segments of a line of the partial image: a search is conducted in a line of the second image for the segments having the same makeup as in the first image but situated at a different position in the image on account of the relative displacement which has occurred between the acquisition of the first image and the acquisition of the second image. The sensor preferably comprises, for this search for correlation over a line segment, a small rectangular zone in which the image of the segment may be found after a displacement of a few pixels globally in the direction of the movement.

In a particular embodiment, it is possible to envisage the correlation being done only in a central zone of the sensor, and the elongate sensor having an image detection zone which comprises practically only a small rectangular area at the center (several lines to be able to detect the displacements with a view to correlation and reconstruction) and a single line outside of the central region (or strictly a few lines but a smaller number of lines than in the central region). This shape of the detection zone leaves more room, on the rectangular silicon chip, to place signal processing circuits used for the correlation and the reconstruction of an image, or even for print recognition.

To simplify the operations for calculating the optimal correlation, a search for correlation will be conducted only with images shifted in a direction which corresponds to the expected direction of movement for the finger with respect to the sensor but not in the opposite direction. For example, one limits the field of the correlation search by performing successive displacements of the second image in several directions and with several possible amplitudes, but only along directions for which the angle with the expected theoretical direction of movement is less than 45°, or even a lesser value.

During the correlation calculation with a view to reconstruction, it is possible to perform correlation calculations which give an optimal correlation value for a displacement which is an integer number of spacings of the pixels; however, when the displacements are slow, a correlation to within a pixel spacing might not be sufficiently accurate. In this case, the best correlations obtained in the neighborhood of the position (to within a pixel) are observed and an interpolation is performed on the basis of two (or more) correlations neighboring the best correlation found, to calculate a value of intermediate displacement which ought to correspond to a still better theoretical correlation; this value of displacement is then a noninteger value of pixel spacings, and this noninteger value is used for the reconstruction. This is preferably done both in the direction of movement and in the perpendicular direction.

Other characteristics and advantages of the invention will become apparent on reading the detailed description which follows and which is offered with reference to the appended drawings in which:

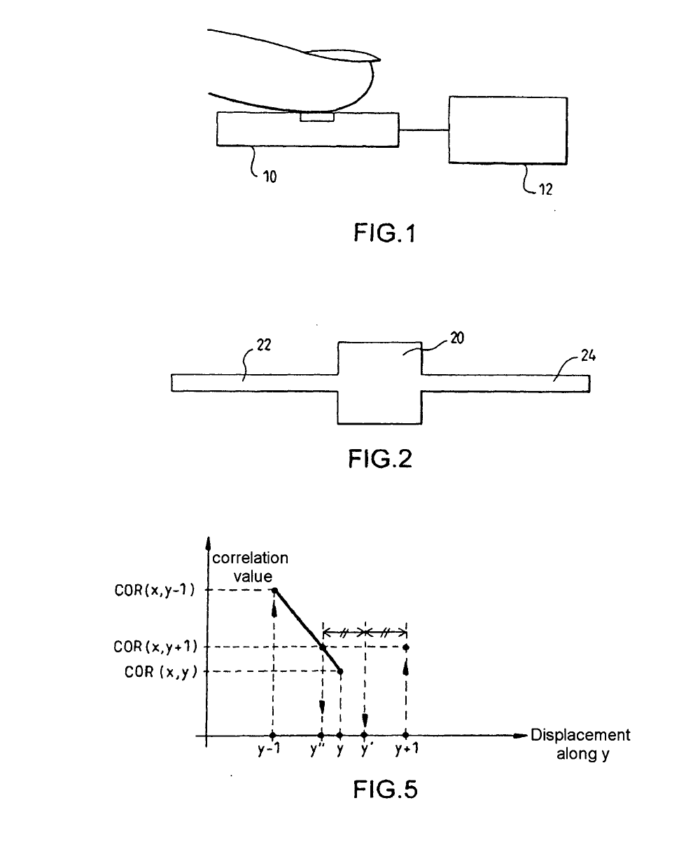

FIG. 1 represents the general print acquisition system;

FIG. 2 represents a preferred shape of active area of the image sensor;

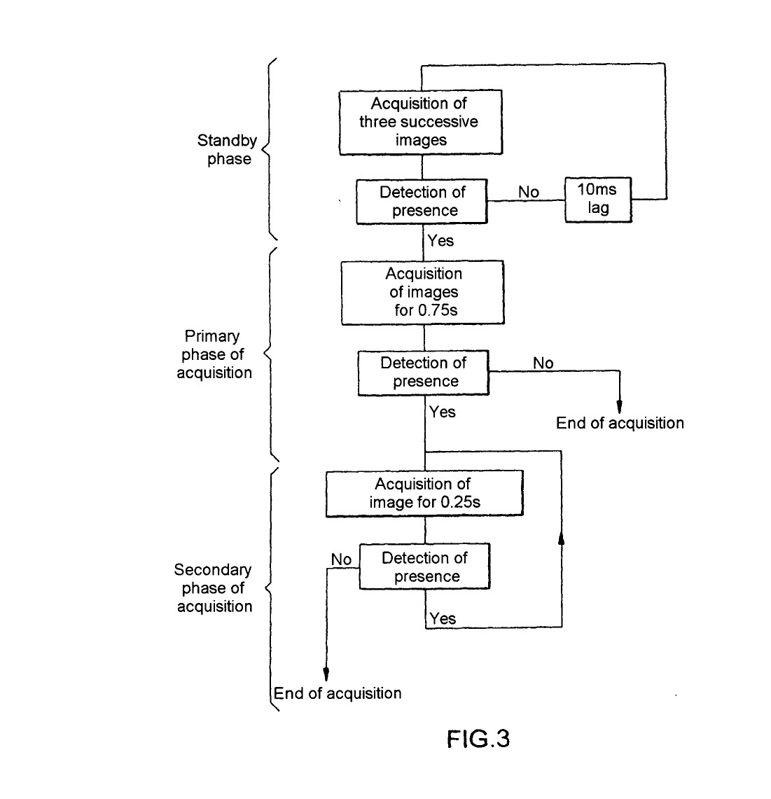

FIG. 3 represents an explanatory flowchart of the general steps of image acquisition;

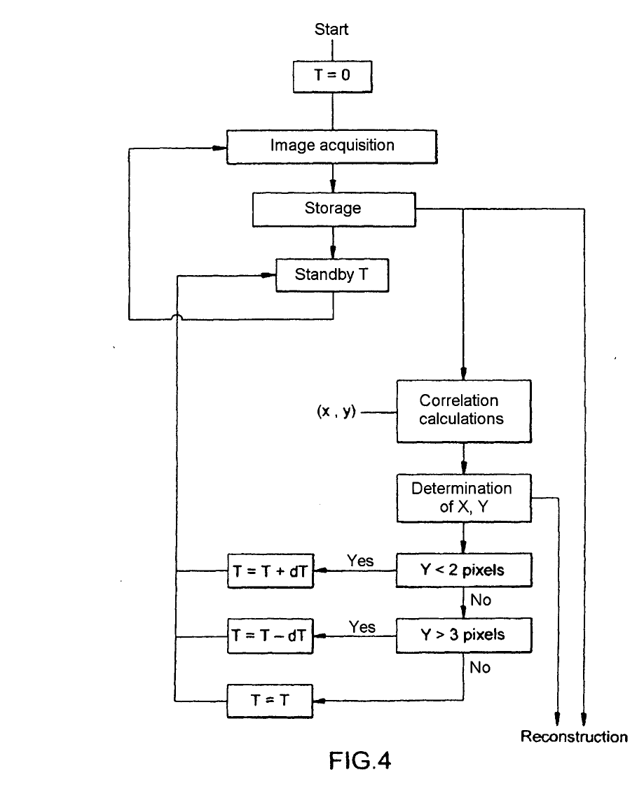

FIG. 4 represents an explanatory flowchart of the acquisition at variable rate;

FIG. 5 represents an interpolation calculation scheme for determining the optimal correlation to within better than a pixel.

The fingerprint acquisition system comprises an image sensor comprising an elongate bar (one or more rows of pixels) in front of which the finger will be displaced. This bar is smaller than the image of the finger so that only a relative movement of the finger with respect to the sensor makes it possible to reconstruct a global print image.

FIG. 1 represents the principle of acquisition, using this sensor 10 and electronic processing circuits 12 serving for the reconstruction of the global image on the basis of the partial images successively detected by the sensor.

The sensor is not necessarily a bar or matrix in the conventional sense having rows which would all have the same number of pixels; it is essentially a matter of one or more main rows of N pixels which will actually serve for the detection of the whole of the image of the finger and of an array of a few rows and a few columns forming a central matrix serving more specifically for the correlation of successive partial images.

The shape of the active area of the sensor 10 is represented in FIG. 2: a small rectangular central region 20 and two elongate wings 22 and 24 lying perpendicularly to the direction of movement represented by the arrow 30; the wings run respectively on either side of the central region; they are aligned and narrower than the central region. The aligned wings and the central region part which extends them by joining them constitute an image detection bar whose length corresponds to the image width that one wishes to detect; for example, the length of the row corresponds to the width of a finger (by way of example 1 to 2 cm approximately); the image detection bar is preferably constructed of a single row of pixels, but if one wishes to optimize the reconstruction, provision may be made for the bar to comprise several rows of pixels. It is the detection bar which provides the partial images serving for the reconstruction of the global image.

The central region is that which will serve to do the correlation calculations, and it is therefore the one which will record partially overlapping images (it is not necessary for the detection bar itself to provide partially overlapping images if the central region provides some). The number of pixels of the central region is chosen to be small enough for the correlation calculation times to be acceptable without thereby overly reducing the accuracy of the correlation calculations. The number of rows of the central region 20 is in principle greater than that of the wings 22 and 24.

The image sensor operates under the control of a processor which will determine the rate of the various captures of a partial image of the finger during its movement and which will determine the way in which the partial images must be reconstructed in order to arrive at a global fingerprint image. The processor may consist of two parts (two processors), one placing the partial images into memory with a view to subsequent calculations, the other performing the correlation calculations, but in principle a single processor suffices to execute the two tasks.

The processor is preferably situated on the same chip as the image sensor but this is not compulsory. In FIG. 1 it has been assumed that the processor forms part of electronic circuits 12 exterior to the chip constituting the image sensor.

The acquisition of the partial images must be fast enough to have a sufficient overlap between the partial images, failing which a reconstruction would not really be possible. The speed of movement of a finger may vary for example between 1 cm/s and 20 cm/s, and is typically of the order of 7 cm/s.

The size of a pixel of the image is typically of the order of 50 micrometers, and for this range of speeds, this corresponds to 200 to 4000 pixels per second in apparent speed on the sensor, i.e. 0.2 to 4 pixels per millisecond.

Assuming that the image sensor comprises only eight rows in the region which is used for the correlation hence in the region where there will necessarily have to be a certain overlap of successive images, it is seen that approximately 700 to 1000 successive acquisitions of partial images per second are necessary in order to obtain an overlapping of images even when the finger is displaced at a maximum speed of 20 cm/s. The overlap will then be on 2 or 3 lines, that is to say the first two or three lines of the second image will in principle be identical to the last two or three lines of the first image. The second image will therefore have, with respect to the first, 2 or 3 common lines and 6 or 5 new lines.

This gives the order of magnitude for which provision must be made for the rate of acquisition of successive images. It is of course possible to improve the partial overlap by increasing the number of rows of the sensor in the central region 20. This number may for example be 20 or 30 rows rather than 8 rows, but this is done of course to the detriment of the cost in terms of area of silicon.

By way of indication, the global image of a finger may correspond to approximately 300×400 pixels after reconstruction.

The sequence for acquiring the image, recalled in FIG. 3, may be as follows:
standby phase: acquisition of a few images (for example 3), and detection by calculation of the presence of a finger. If a presence is detected, passage to the next phase, otherwise, standby for some ten milliseconds before a new acquisition of a few images and a new detection of presence; the lag of ten milliseconds ensures that even in the case of a maximum speed of 20 cm/s no more than a few millimeters of image will be lost if a finger has begun to move between two detection attempts;
primary phase of acquisition: partial images are arbitrarily acquired for, for example, three quarters of a second; most of the time this duration will be sufficient for complete acquisition of the image of the finger since this duration corresponds to a movement at fairly low speed (2.6 cm/s for an image 2 cm long); after this time the presence of a finger in the last few partial images is calculated; if the finger is still present, we go to the next phase; otherwise the image acquisition is terminated and we can go to the next phase;
secondary phase of acquisition, for the case where the movement of the finger was particularly slow: if the finger is present, acquisition of partial images continues but only for a quarter of a second, and the presence of the finger on the last few slices is tested; if the finger is present, acquisition is recommenced for a new period of a quarter of a second, otherwise acquisition is terminated and we go to reconstruction.

The partial images thus acquired may be stored with a view to their subsequent processing, or else the reconstruction may commence progressively during the acquisition periods. The first case requires a significant memory with more reduced means of calculation; the second case requires significant means of calculation with a more reduced memory.

The detection of the finger may be effected by monitoring of the standard deviation between the signal levels of the pixels of the central part of the image. When the finger is not present, the standard deviation is small, it corresponds only to noise. When the finger is present it increases greatly and it suffices to choose a fairly high detection threshold, making it possible not to trigger acquisition on simple noise.

Stoppage of acquisition is done on the same principle, over a sufficient duration (20 ms for example) for it to be certain that the finger has completely left the sensor (and with a lower threshold than the previous one so as to avoid instability).

To perform the global image reconstruction on the basis of partial images, it is necessary to calculate the displacement of the finger from one image to the next.

To do this, a method of correlation requiring only a small calculation power is preferably adopted so that the correlation of two successive images takes a small time (order of magnitude: 1 millisecond to find the best correlation between two images).

A simple and effective correlation calculation consists in calculating the difference between two values of pixels Pi and Pj corresponding to two possible positions of the same real image point in two successive partial images, and in adding together the absolute values of the deviations (or alternatively the squares of the deviations) for all the pixels Pi of the correlation zone. Stated otherwise, if Pi is the signal value of a determined position of pixel i of the first image, Pj is the value of another position of pixel j, measured in the second image, and the pixels i and j are separated by a distance x along the abscissa and y along the ordinate. The abscissa is counted in the direction of the length of the elongate bar, the ordinate is counted in the perpendicular direction (that is to say essentially in the direction of movement of the finger).

The correlation value to be tested is calculated on the basis of this absolute value of sum of deviations for all the pixels of the correlation zone; the correlation zone is a smaller rectangle of the first image than the central region 20 in which the correlation is done. The correlation value COR(x,y) for a displacement (x,y) is related to a possible image displacement x, y and of course, all the pixels i (i varying from 1 to n if there are n pixels in the correlation zone) which will form the subject of this calculation of correlation value for a displacement x, y are displaced by the same value x, y. The smaller the correlation value, the larger the probability that the second image is actually the image of the same portion of finger that was viewed by the first image during the previous acquisition. It will be understood that the sum of the deviations Pi−Pj is always smaller when the images are better correlated, consequently, the best correlation value corresponds to a minimum value of the correlation quantity; however other correlation quantities could be chosen, which would correspond to the search for a maximum for the best possible correlation. The solution advocated here (correlation optimized by searching for a minimum of a sum of deviations) makes it possible to simplify the calculations.

Several correlation values are calculated, for various values of x, y and we search for that displacement x, y which gives the smallest value.

In principle x and y are expressed as integer numbers of pixels, but it will be seen that it is possible to refine the search for a maximum correlation for fractions of pixels.

Preferably, the number of pixels over which the correlation is performed is limited. For example, the correlation is performed over a line segment taken in the central region 20 of the active zone. This segment preferably has a length that is smaller than the width of this central zone, so as to take account of the fact that the image displacement may be slightly oblique. The segment is preferably situated in the front part of this central region of the sensor, that is to say the part which sees a new portion of finger image first. Specifically, having regard to the direction of movement of the finger, a finger image portion which appears initially in the front part of a first image will shift progressively towards the rear part in tandem with the movement of the finger in the direction envisaged and it will be possible to search for the correlation between a portion of image line situated in the front part of the first image and a portion of image line situated further to the rear. This presupposes that the direction of movement of the finger is imposed; in the converse case, the portion of line for which a correlation in the subsequent images is sought ought to be in the central part of the region 20.

It will be noted that if the shape of the active zone of the sensor were simply rectangular, in contradistinction to the case represented in FIG. 2 where the zone is cross shaped, the correlation could be performed differently, for example over several line segments taken in the active zone: relative displacements of each segment would be sought.

It is preferable for the correlation calculation to be performed over a fixed number of pixels, for example 64, a simple binary number which simplifies the divisions for the correlation calculation.

A correlation calculation will be done for example from the following values of image displacement expressed, both horizontally and vertically, in numbers of pixels:

(0, 1); (0, 2); (0,3); (0,4) (displacements in the direction of movement)

(1, 1); (1, 2); (1, 3); (1, 4) (slightly oblique displacement to the right)

(−1, 1); (−1, 2); (−1, 3); (−1, 4) (slightly oblique displacement to the left)

and possibly of other more oblique values of displacement if one wishes to widen the possibilities of detection of displacement and of reconstruction to directions sharply deviating from the nominal direction of movement.

According to the invention, it is not in general necessary to search for correlations in respect of displacements of greater amplitudes than those indicated hereinabove (4 pixels vertically in the direction of movement). In total, an optimal correlation search from among 16 possible values of displacement ought to be sufficient with the principle of the invention.

Specifically, one chooses to adapt the rate of capture of partial images as a function of the result of the correlation in such a way that the subsequent correlations are optimal for small displacements. This amounts to adapting the rate of image acquisition to the speed of displacement of the finger in a direction tending to aid the correlation calculations and reconstruction.

The basic assumption is that the finger is displaced while undergoing only small accelerations or no accelerations at all, and it is therefore possible to suppose that if the speed has a given value at the moment of an image acquisition, it will have practically the same value during the following acquisition.

On the one hand, this amounts to saying that it is practically possible to predict (after a few trials allowing approximate determination of the speed) the position of the next image, to within one or two pixels. However, above all, it is possible to adapt the time interval between two acquisitions so that the displacement between two acquisitions remains on average equal to 2 or 3 pixels (in particular in the case of a sensor having eight rows in the correlation zone).

This value of 2 or 3 pixels could be increased if the sensor had more than eight rows in the correlation zone, but, in order to minimize the calculations, it is beneficial not to overly increase the size of the correlation zone.

The rate of acquisition must therefore be able to be sufficient so as not to exceed a displacement of 2 to 3 pixels (preferred value) for a maximum speed of the finger; conversely, this rate is not maintained in the case of a slow speed of the finger, since maintaining it would culminate in overly small image displacements between two acquisitions and the search for correlation between two successive images would have only little meaning, especially if the correlation makes it possible to determine a displacement only to within a pixel.

The rate is therefore slowed down in case of slow displacement, so as to acquire a new image only when the finger has displaced by 2 or 3 pixels. It is interesting to note that this time can be exploited in order for the signal detected by the sensor to be integrated for longer, when the type of sensor requires a fairly long integration time to provide a useable signal: this is the case with sensors operating on a thermal effect (variation of temperature or of thermal conduction between the ridges and the valleys of the fingerprints).

The acquisition rate adaptation algorithm, shown diagrammatically in FIG. 4, is as follows: if we consider the reading of an image to last a time t1 and the time interval or “standby time” before the reading of the next image to be T, we proceed as follows:
a) initially, a standby time T between two acquisitions is set to zero, this implying that the acquisition rate is a maximum; this makes it possible a priori to be ready for the case where the displacement of the finger is effected at particularly high speed;
b) a first acquisition of an image is carried out followed by a second with this zero standby time between the two;
c) the search for maximum correlation is performed by calculating the value of correlation between the second image and the first image shifted by x, y, and this is done for various displacements x, y of the first image; the value X, Y which gives the best correlation value is determined; this value represents the displacement vector of the image of the finger between the two acquisitions;
d) if the displacement (essentially in the y direction of expected movement of the finger) is less than a low threshold, preferably 2 pixels, the standby time T is incremented by a certain value dT (typically 50 microseconds); if conversely it is greater than a high threshold, preferably 3 pixels, it is decremented by the same amount, provided that it is not already zero; if the displacement is equal to 2 or 3 pixels, the standby time is not modified.

After convergence to a standby time T adapted to the speed of the finger, alterations are slow since the finger undergoes no meaningful acceleration, and the standby time oscillates between T−dT and T+dT.

In the search for this convergence to an appropriate standby time, the standby time is limited to a certain value Tmax beyond which it is no longer incremented (typically some 10 milliseconds); this maximum value depends on the minimum speed demanded for the displacement of the finger, typically 1 cm/s. At lower value, T is obviously limited to 0.

The choice of the lower and upper thresholds of displacement may be different from 2 and 3 pixels. The thresholds could be equal, but by making them different we avoid irrelevant oscillations of the standby time. They could be decreased down to 1 and 2 pixels but then the image reconstruction is less accurate; they could be increased, but then it is necessary to make sure that the sensor has sufficient rows in the correlation zone to take account of the more significant displacements, and moreover the search for correlation takes more time since it is in principle necessary to calculate a larger number of correlation values over a larger range of possible displacements x, y.

FIG. 4 recalls the flowchart of this part of the processing. Of course, after each image acquisition giving rise to the calculation of a new delay T, the second image acquired becomes the first image for the acquisition sequence and correlation search that follows.

After the acquisition of the various partial images of a finger that are progressively shifted as a function of the speed of displacement of the finger, the global image of the finger is reconstructed. According as the calculation power and the memory available for storing the partial images are more or less sizeable, the reconstruction is performed in tandem with acquisition or after the end of all acquisitions.

In both cases, starting from the moment where the rate of acquisition has been stabilized in such a way that the image displacement between two acquisitions is constant (2 or 3 pixels on average), it is not practically necessary to take account of the value of this rate. To reconstruct the global image of the finger, it suffices to juxtapose the successive images shifted each time by the displacement value which gave the best possible correlation and which is on average 2 or 3 pixels in the direction of the movement (vertical) and close to zero in the perpendicular direction (horizontal) if the finger is indeed displaced in the direction of movement.

However, to refine the image reconstruction, it is preferable to search for the maximum correlation to within better than a pixel, both vertically and horizontally. Specifically, over a small displacement such as 2 or 3 pixels, correlation values will be found which have little chance of corresponding to an image displacement equal to an integer number of pixels.

Thus, if several correlation values are found for various displacements expressed as an integer number of pixels, and if two correlation values COR(x, y−1) and COR(x, y+1) flank the highest correlation value COR(x, y), it is possible to deduce from the three values a displacement x, y′ expressed as a fraction of pixels in the direction of movement which corresponds better to the correlation peak than the displacement x, y which apparently gives the best correlation to within a pixel.

FIG. 5 illustrates a way of calculating this approximation of the displacement which gives the best correlation to within better than a pixel on the basis of calculations done to within a pixel. The algorithm is as follows, explained on the basis of a graph as well as in practice, the algorithm is of course executed by software on the basis of equations representing the plots on the graph: charted on the graph (displacement y along the abscissa, values of correlations along the ordinate) are the three values COR(x,y), COR(x, y−1) and COR(x, y+1), among which there is a point of best correlation having a minimum correlation value COR(x,y), a point having a maximum correlation value (one of the other two points), and a point having an intermediate correlation value (the other of the two points); the segment which connects the point of maximum correlation and the point of minimum correlation is plotted; the abscissa y″ of the point of this segment which has the intermediate correlation value as ordinate is determined; and the abscissa value y′ which is the midpoint between the abscissa y′ and the abscissa of the point of intermediate correlation (y+1 or y−1) is calculated.

Thus, for example, if the point having the intermediate correlation value is the point with abscissa x, y+1 and with ordinate COR(x, y+1), the point of optimal correlation approximated to within better than a pixel will be the point with abscissa y′=(y″+y+1)/2.

In the converse case, if the point of intermediate correlation is COR(x, y−1), the point of maximum correlation to within better than a pixel will be the point with abscissa y′=(y″+y−1)/2.

It is this value y′ which will constitute the value Y of the displacement between the second image and the first image in the direction of a movement.

The same interpolation may be done to determine the displacement X to within better than a pixel in the direction perpendicular to the movement, on the basis of the two values of correlation COR(x−1, y), and COR(x+1, y) which flank the value of best correlation COR(x,y).

During image reconstruction, each image is associated with the displacement X, Y calculated with respect to the previous image, and the images thus progressively shifted are juxtaposed to reconstruct the global image. This juxtaposition may be done in a matrix of greater resolution than a pixel of the sensor if the displacements X, Y are sought to within better than a pixel. However, it is possible and even preferable to do the juxtaposition in a matrix of resolution 1 pixel, but this presupposes an adaptation of the reconstruction method; this adaptation is as follows: for the superposition of a partial image in the global image, a displacement value is defined which is taken not with respect to the previous image (since then it would have been pointless to have calculated the displacement to within better than a pixel to then transfer it into an image defined to within a pixel) but with respect to the whole of the first image acquired: the displacement of an image with respect to the whole of the first image is the integral of all the successive displacements each calculated to within better than a pixel, and it is this integral which is transferred to within a pixel into the global image reconstruction matrix. A partial image is therefore shifted by a displacement value counted with respect to a first image acquired, by aggregating the successive displacements of the partial images acquired between the first image and the partial image considered.

1-10. (canceled)

11. A method of acquiring a fingerprint image by moving a finger in front of an elongate sensor of images, comprising the steps of:
acquiring a succession of mutually overlapping partial images, under the control of a processor,
searching for a displacement of a first image, with respect to a second image, which affords the best correlation between the first and second images, and determining, as a number of image pixels being a component of the displacement in a direction perpendicular to the elongate sensor,
comparing the component of displacement with at least one threshold,
as a function of the result of the comparison, maintaining, or increasing or decrementing by a time increment dT, a delay T imposed by the processor before the acquisition of a next image.

12. The method as claimed in claim 11, wherein the best correlation is sought on the basis of displacements both in the length direction and in the width direction of the image sensor, and a global image of the finger is reconstructed by superimposing the shifted images which give the best correlation between successive images.

13. The method as claimed in claim 11, wherein, at each new image, the acquisition delay is readjusted in a direction tending to make the displacement which gives the best correlation remain almost constant around the threshold considered from one acquisition to the next.

14. The method as claimed in claim 13, wherein there is provision both for a high threshold and for a low threshold, the overshooting of the high threshold bringing about a decrementation by dT of the delay T and the undershooting of the low threshold bringing about an incrementation by dT of the delay T.

15. The method as claimed in claim 14, wherein the difference between the high threshold and the low threshold is one pixel.

16. The method as claimed in claim 15, wherein the thresholds are respectively 2 and 3 pixels.

17. The method as claimed in claim 11, wherein the correlation is performed on a restricted portion of the image provided by the sensor.

18. The method as claimed in claim 17, wherein the correlation is effected only in a central zone of the sensor, the sensor having a small number of rows over the whole of its width and additional rows of smaller length in its central part so as to constitute a central correlation zone.

19. The method as claimed in claim 11, wherein correlation calculations are performed for displacements which are integer numbers of spacings of the pixels, and an interpolation calculation is performed on the basis of two (or more) correlations neighboring the best correlation calculated so as to find a value of intermediate displacement to within better than a pixel which ought to correspond to a still better theoretical correlation, and this intermediate displacement value is used during the reconstruction of a global image by juxtaposition of shifted partial images.

20. The method as claimed in claim 19, wherein, for the reconstruction of a global image, a partial image is shifted by a displacement value counted with respect to a first image acquired, by aggregating the successive displacements of the partial images acquired between the first image and the partial image considered.
